(19) United States
(12) Patent Application Publication
(10) Pub. No.: US 2013/0039775 A1
(43) Pub. Date: Feb. 14, 2013

(54) METHOD FOR PRODUCING WIND POWER PLANT ROTOR BLADES AND A WIND POWER PLANT ROTOR BLADE

(71) Applicants: Sven Muschke, Schortens (DE); Johannes Kannenberg, Aurich (DE)

(72) Inventors: Sven Muschke, Schortens (DE); Johannes Kannenberg, Aurich (DE)

(73) Assignee: WOBBEN PROPERTIES GMBH, Aurich, DE (DE)

(21) Appl. No.: 13/579,907

(22) PCT Filed: Feb. 18, 2011
(86) PCT No.: PCT/EP2011/052422

§ 371 Date: Oct. 29, 2012

(30) Foreign Application Priority Data
Feb. 18, 2010 (DE) 10 2010 002 131.8

(51) Int. Cl. F03D 11/00; B29C 45/14; F03D 1/06

(52) U.S. Cl. 416/241 A; 416/223 R; 264/258; 425/117

(57) ABSTRACT

The present invention concerns a process for the production of a wind power installation rotor blade. To permit more economical manufacture at high quality the following steps are provided: providing at least one mold, placing a layered fiber composite having at least one core in the mold, wherein the core has a top side with first channel portions and an underside with second channel portions, and connecting portions between the first and second channel portions, and feeding resin, in particular through the first and/or second channel portions, until the layered fiber composite is adequately saturated.

### BACKGROUND

1. Technical Field

The present invention concerns a process for the production of wind power installation rotor blades and a wind power installation rotor blade.

2. Description of the Related Art

As rotor blades of wind power installations which are often in the form of fiber composite components are regularly exposed over years to the weather and also extreme weather conditions, they must also be able to withstand them. That is on the one hand a matter for the design of the rotor blades. On the other hand the rotor blades must then also actually have appropriate material properties. That already arises out of the fact that it is precisely the fiber composite structure that makes it possible to produce components which can bear loads and which are long-lasting. Thus rotor blades for wind power installations are typically produced in a vacuum infusion process. In that case glass fiber mats as well as hard foam or balsa wood as the core are laid out in a mold for the rotor blade and saturated with resin by means of a pump and a hose system under vacuum. Thus the rotor blade then comprises a core element and glass fiber-reinforced epoxy resin on both sides of the core in a sandwich structure.

In that case the resin is typically infused or injected in a vacuum infusion or vacuum injection process. In that case it is possible to provide a film in order to produce a vacuum beneath the film. The vacuum is particularly advantageous because it leads to improved spreading of the resin. Usually a flow aid is placed between the core and the other layers of the layered structure. The flow aid serves to provide that the resin can spread quickly so that the material of the rotor blade is uniformly saturated.

WO 2009/003477 A1 describes a process for the production of a rotor blade. That involves using a core which has grooves on one or both sides. The grooves in the core are intended to serve to be able to better bend the core.

### BRIEF SUMMARY

An object of the present invention is to provide a process for the production of composite fiber components and in particular rotor blades for wind power installations, which permits more economical production at uniformly high quality.

That object is attained by a process according to claim 1 and by a wind power installation rotor blade according to claim 3.

Thus there is provided a process for the production of a wind power installation rotor blade or a fiber composite component. In that case there is provided at least one mold and a layered fiber composite with at least one core is placed in the at least one mold. The core has a top side having first channel portions and an underside having second channel portions as well as connecting portions between the first and second channel portions. The first and second channel portions alternate. Resin can be fed in particular through the first and/or second channel portions until the layered fiber composite is adequately saturated.

Thus there can be provided a process for the production of wind power installation rotor blades, in which no flow aids are needed.

In an aspect of the present invention the feed of resin is effected in a vacuum injection process.

The present invention also concerns a wind power installation rotor blade or a fiber composite component having at least one core having a first side and a second side. Provided in the first side is at least one first channel portion while provided in the second side is at least one second channel portion. There are also connecting portions at the transitional regions of the first and second channel portions.

In an aspect of the present invention the first and second channel portions alternate along the length of the core.

In a further aspect of the invention the first and second channel portions are milled into the core.

The invention concerns the concept of providing at least one channel in the core or the core material of a wind power installation rotor blade or a fiber composite component. In that case a channel is at least partially produced on the top side and at least one channel is at least partially produced on the underside, wherein there is a connecting portion between the channel portions on the top side and the channel on the underside. That can be effected for example by a through bore in the region of an overlap of the channels of the top side and the underside. However that can also be effected for example by way of adjustment of the channel depth. If that is set to be somewhat greater than half the material thickness, then through openings, that is to say communications between both channels, will automatically arise in the overlap region of the channels in the top side and the underside. The resin can now be fed to the channel or channels. The resin can uniformly spread over the entire length of the channel and thus along the entire core material or the entire layered fiber composite, through the connection at the overlaps of the channels at the top side and the underside.

A feedhead, that is to say a connection for feeding the resin, can be provided both on the top side and also on the underside in order to feed the resin.

In that case the feedheads can be provided for example at the outer ends of the channels.

If there are a plurality of cores having channels in the fiber composite component, then a transverse milling can be provided at the junctions between the cores in order to provide a communication of the channels with each other.

In an aspect of the invention the channels are produced by milling in the cores. In that way it is possible to produce the channels with known and reliably managed and tried-and-tested working procedures. In that respect the channels can already be produced upon manufacture of the cores so that the cores are in the form of finished semi-manufactured articles when they are placed in the mold.

In addition, when using degassed resin, a rotor with a high level of strength can be embodied by the resin being free of gas bubbles such as for example air inclusions.

Further configurations of the invention are subject-matter of the appendant claims.

### BRIEF DESCRIPTION OF THE SEVERAL VIEWS OF THE DRAWINGS

Advantages and embodiments by way of example of the invention are described in greater detail hereinafter with reference to the drawing.

FIG. 1 shows a diagrammatic perspective view of a core element of a wind power installation rotor blade according to a first embodiment,

FIG. 2 shows a simplified plan view of such a core element, and

FIG. 3 shows a diagrammatic view of a wind power installation according to the invention.

### DETAILED DESCRIPTION

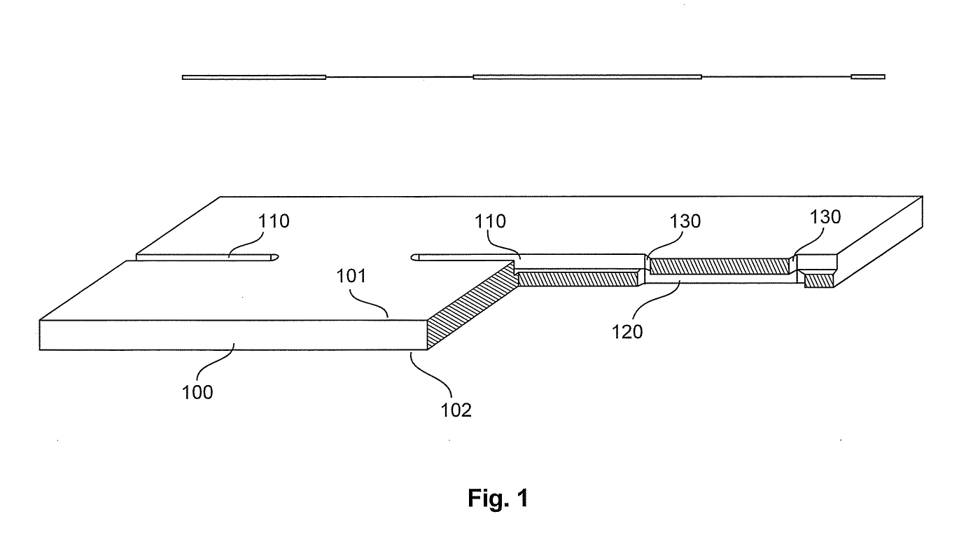

FIG. 1 shows a diagrammatic perspective view of a core of a fiber composite component such as for example a wind power installation rotor blade in accordance with a first embodiment. The core 100 has a top side (first side) 101 and an underside (second side) 102. A plurality of first channel portions 110 are produced, for example by milling, in the top side 101, and a plurality of second channel portions 120 are provided, for example by milling, on the underside 102. Connecting portions 130, for example in the form of through bores 130, can be provided at the transitional or overlap regions between the first and second channel portions 110, 120. Thus there is a continuous channel comprising first channel portions, second channel portions and connecting portions 110, 120, 130. If the channel portions 110, 120 are somewhat deeper than half the material thickness, that automatically affords a connection in the overlap region of those channel portions 110, 120. The core can be in the form of a solid plate.

The channel thus extends partially at the top side 101 and partially at the underside 102. In particular the channel extends alternately on the top side and the underside 101, 102, but it can also be of a continuous configuration, by virtue of the connections 130. For example a resin such as for example a glass fiber-reinforced epoxy resin can be introduced into that channel using a vacuum infusion process, the resin then spreading further from the channel until the core element is completely covered with a predetermined thickness of resin.

To finish a fiber composite component according to the invention and in particular a wind power installation rotor blade, the core or the core element 100 and for example glass fiber mats can be placed in a mold, for example a half-shell arrangement. The resin can then be fed to the channel 110, 120 in a vacuum infusion process, in which case the resin firstly fills up the channel and is then distributed uniformly in the layered fiber composite or non-crimp fabric on and under the core element 100. In that case the amount of resin is such that the layered fiber composite is sufficiently impregnated.

In that way the channel with the first and second channel portions 110, 120 can be used for transporting the epoxy resin. The epoxy resin can be fed by way of a feedhead at the ends of the channels 110, 120 both at the top side and also at the underside in order to spread quickly and uniformly in the mold through the channel according to the invention and to thoroughly saturate the layered fiber composite.

The epoxy resin can optionally be fed directly by way of a feedhead both at the top side and also at the underside or indirectly by way of the channels.

When a plurality of cores are provided in a rotor blade then transverse millings or transverse channels can be provided at the junctions in order to provide a connection between the channels in the individual cores and thus to promote spreading of the resin over the entire fiber composite component or the entire mold.

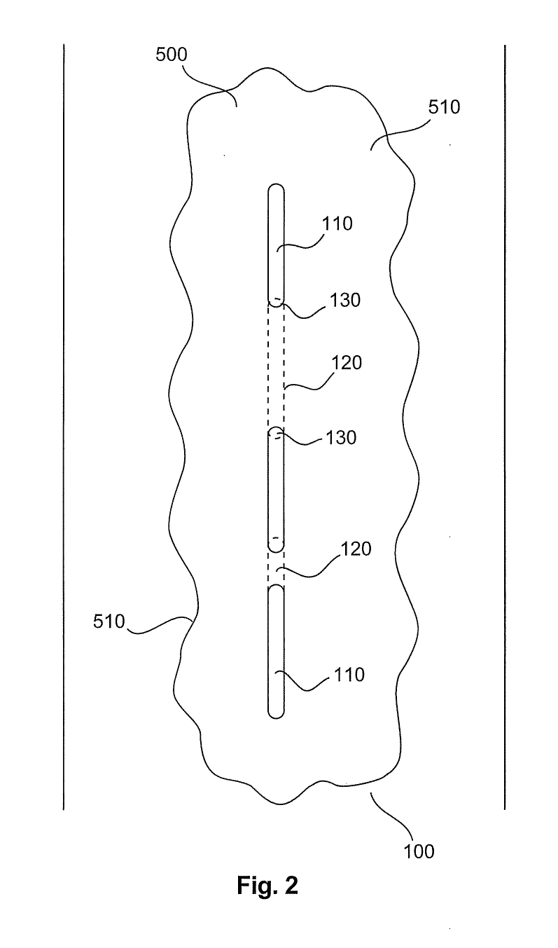

FIG. 2 shows a diagrammatic view of a part of a core according to the invention or a core element 100 for a fiber composite component such as for example a wind power installation rotor blade, in which resin 500 is fed for example in a vacuum injection process. As can be seen from FIG. 2 the resin 500 has already partially spread out. In that respect it can be seen from FIG. 2 that the resin spreads out along the channel 110, 120, 130. The spreading front of the resin, which is shown in this Figure, referred to for brevity as the resin front 510, shows uniform spreading of the resin and thus shows that the layered fiber composite is also uniformly saturated.

The time for production of a wind power installation rotor blade can be reduced by the process according to the invention for the production of a fiber composite component or a wind power installation rotor blade. In addition flow aids are no longer required.

Production of a rotor blade in one piece can be simplified with the process according to the invention for the production of a wind power installation rotor blade.

The wind power installation rotor blade according to the invention can be produced for example in a sandwich process. For that purpose for example a sandwich material such as for example PVC foam, balsa wood and so forth is provided as a rotor blade core. A channel can be milled in the core, as described above. Transport of the resin can be made possible or accelerated, through that channel. The provision of connecting locations or ground-away portions between the milled-out areas at the top side and the underside means that the resin or the matrix can spread out in the entire channel. The feed of resin can be effected directly by way of a feedhead on the top side or underside or indirectly by way of channels in the component or in the core. If the core comprises a plurality of pieces, transverse millings can also be provided at the junctions of those pieces in order to ensure that the channel is connected.

The resin can spread out more quickly within the channel than outside it. Thus it is possible to omit the flow aids when using the resin channel. The resin channel is preferably provided in the longitudinal direction of the core element so that the resin can spread out quickly through the resin channel along the longitudinal direction and can then spread out further beyond the channel.

That can lead to the resin spreading out more uniformly as spreading of the resin takes place more quickly within the resin channel than outside it.

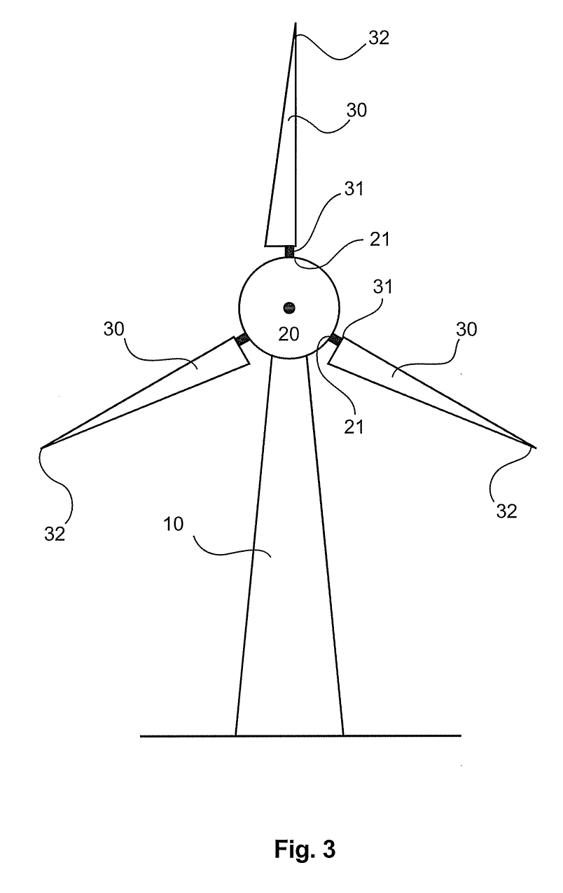

FIG. 3 shows a diagrammatic view of a wind power installation according to the invention. The wind power installation 1 has a pylon 10 with a pod 20 at the upper end of the pylon 10. For example three rotor blades 30 are arranged on the pod 20. The rotor blades 30 have a rotor blade tip 32 and a rotor blade root 31. The rotor blades 30 are fixed for example to the rotor hub 21 at the rotor blade root 31. The pitch angle of the rotor blades 30 is preferably controllable in accordance with the currently prevailing wind speed.

The wind power installation rotor blades 30 in FIG. 3 can be produced in accordance with the first embodiment.

The various embodiments described above can be combined to provide further embodiments. All of the U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified, if necessary to employ concepts of the various patents, application and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A process for the production of a rotor blade, in particular a wind power installation rotor blade, comprising the steps:
providing at least one mold,
placing a layered fiber composite having at least one core in the at least one mold, wherein the core has a top side with first channel portions and an underside with second channel portions and connecting portions) between the first and second channel portions,
wherein the first and second channel portions alternate along the length of the core, and
feeding resin, in particular through the first and/or second channel portions, until the layered fiber composite is adequately saturated.

2. The process according to claim 1 wherein the feed of resin is effected in a vacuum injection process.

3. A wind power installation rotor blade comprising
at least one core which has a first side and a second side, wherein at least one first channel portion is provided in the first side and at least one second channel portion is provided in the second side, wherein there are provided connecting portions at the overlap regions of the first and second channel portions,
wherein first and second channel portions alternate along the length of the core.

4. The rotor blade according to claim 3 wherein the first and second channel portions are milled into the core.

5. The rotor blade according to claim 3 wherein the core represents a stable plate.

6. A wind power installation having at least one wind power installation rotor blade according to claim 3.

7. The rotor blade according to claim 3 wherein the core is made of PVC foam.

8. The rotor blade according to claim 3 wherein the core is made of balsa wood.

9. The rotor blade according to claim 3 wherein the first channel portions are provided in a longitudinal direction of the core.

10. The rotor blade according to claim 3 wherein the second channel portions are provided in a longitudinal direction of the core.

11. The rotor blade according to claim 3 wherein the first and second channel portions are deeper than half the core thickness.

12. The process according to claim 1 wherein the resin is degassed resin.

13. The process according to claim 1 wherein the feed of resin is provided at the outer ends of the first channel portions.

14. The process according to claim 1 wherein the feed of resin is provided at the outer ends of the second channel portions.

15. The process according to claim 1 wherein the feed of resin is provided both on the top side and on the underside.

16. A core for production of a wind power installation rotor blade comprising:
a first side;
a second side;
at least one first channel portion in the first side;
at least one second channel portion in the second side;
at least one connecting portion at an overlap region of the at least one first channel portion and the at least second channel portion; and
an opening between the first channel portion and the second channel portion at the overlap region.

17. The core according to claim 16, wherein the first and second channel portions alternate along the length of the core.

18. A tool for making wind power installation rotor blade comprising: a mold having a cavity;
at least one core positioned in the cavity of the mold which has a first side and a second side;
a first means for feeding resin in the first side; a second means for feeding the resin in the second side; and
a means for connecting the first side and the second side at overlap regions of the first and the second means.

19. The tool according to claim 18, wherein the first and the second means alternate along the length of the core.
